(19) United States
(12) Patent Application Publication
(10) Pub. No.: US 2008/0191547 A1
(43) Pub. Date: Aug. 14, 2008

(54) Pressure Fluid Reservoir, Reservoir Unit, and Method For Producing a Pressure Fluid Reservoir

(76) Inventors: Andreas Weh, Sulzberg (DE); Alexander Bareiss, Immenstadt (DE); Nathan McCormick, Advance, NC (US); Holger Fischer, Haldenwang (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/909,753

(22) PCT Filed: Feb. 21, 2006
(86) PCT No.: PCT/EP2006/060119

§ 371 Date: Sep. 26, 2007

(30) Foreign Application Priority Data
Apr. 4, 2005 (DE) 102005015262.7

(51) Int. Cl. B60T 17/06

(52) U.S. Cl. 303/66

(57) ABSTRACT

A pressure fluid reservoir for a traction-controlled vehicle brake system; a reservoir unit including a plurality of pressure fluid reservoirs; and a method for producing a pressure fluid reservoir are disclosed. The pressure fluid reservoir with its structural size unchanged, has a larger installation space for a restoring element cooperating with a reservoir piston and at the same time can be produced economically. To that end, as the reservoir piston, a component reshaped in non-metal-cutting fashion from a sheet-metal material is proposed, on whose circumference an encompassing receptacle for a piston seal is integrally formed, likewise in non-metal-cutting fashion. The reservoir piston can be produced by deep drawing; the receptacle for the piston seal can be produced by roller-burnishing. Both method steps can be performed economically in one combined operation.

### PRIOR ART

The invention is based on a pressure fluid reservoir as defined by the generic characteristics of the preamble to claim 1, a reservoir unit comprising a plurality of pressure fluid reservoirs as generically defined by the characteristics of the preamble to claim 9, and a method for producing a pressure fluid reservoir as generically defined by the characteristics of the preamble to claim 10.

Pressure fluid reservoirs are used in hydraulic circuits of traction-controlled vehicle brake systems, for instance. Their task is to receive pressure fluid from one of the wheel brakes, so that when needed a rapid reduction in the brake pressure in this wheel brake is made possible. Besides a hydraulic communication with a wheel brake, the pressure fluid reservoir has a hydraulic communication with the intake side of an electrically drivable pressure generator of the vehicle brake system. This pressure generator evacuates the pressure fluid reservoir depending on the operating state of the vehicle brake system by aspirating stored pressure fluid from the pressure fluid reservoir and feeding it back into one of the brake circuits or to a master cylinder.

Known pressure fluid reservoirs have a reservoir housing and a reservoir piston received axially displaceably in the reservoir housing. The reservoir piston cooperates with a restoring element and has a piston seal in a receptacle on the circumference. The piston seal divides the interior of the reservoir housing into two reservoir chambers sealed off from one another. One of these reservoir chambers can be filled with the pressure fluid of the vehicle brake system, and the other reservoir chamber receives the restoring element of the reservoir piston and is typically ventilated. Known reservoir pistons are made from plastic.

For strength reasons, among others, plastic reservoir pistons have a relatively thick minimum wall thickness. This limits the installation space available for the restoring element in the reservoir housing. The largest possible installation space, however, is worth striving for, because then by adapted dimensioning of the restoring element, a pressure fluid reservoir with a low response pressure yet at the same time the highest possible restoring force can be furnished.

In addition, reservoir pistons of plastic have decreasing strength values as the ambient temperature rises. This limits the freedom in terms of structural design of the reservoir piston still further. When a plastic reservoir piston is installed in a reservoir housing, special care must furthermore be taken to avoid damage or soiling from abrasion.

### ADVANTAGES OF THE INVENTION

By comparison, a pressure fluid reservoir having the definitive characteristics of the body of claim 1 and a reservoir unit having the definitive characteristics of the body of claim 9 and a method for producing a pressure fluid reservoir in accordance with the characteristics of claim 10 have the advantage that relatively thin-walled components, economically made from a sheet-metal material by creative shaping, can be used as the reservoir piston, taking up little installation space and having higher strength values, even at rising ambient temperatures, than known reservoir pistons of plastic.

Because of the low structural space requirement of a reservoir piston according to the invention, a larger installation space is available for the restoring element. This makes greater freedoms possible in structurally meeting the functional demands made of the restoring element. A reservoir piston of the invention can be produced with the requisite quality in terms of diameter and roundness without postmachining.

The receptacle for the piston seal can be made simultaneously with the proposed mode of producing the reservoir piston.

Further advantages or advantageous refinements of the invention will become apparent from the dependent claims or the ensuing description. A creative shaping production process makes it simple and economical to provide regions of different wall thicknesses in the reservoir piston. Especially the heavily loaded piston bottom can as a result be made with a greater wall thickness than the less heavily loaded shaft of the reservoir piston (claim 2). According to claim 3, the receptacle for the piston seal can advantageously be dimensioned such that its inside diameter simultaneously forms a radial brace for the restoring element located in some portions in the interior of the reservoir piston. To prevent the creation of a sharp edge on the open end of the reservoir piston as a result of the creative shaping production process of the reservoir piston, a sharp edge that could cut into the wall of the reservoir housing and hinder the mobility of the reservoir piston, it is proposed according to claim 4 that the piston wall be rolled inward in some portions. Friction-reducing provisions for the reservoir piston are also claimed in dependent claims 5 and 6. Dependent claims 7 and 8 claim advantageous features for the reservoir housing and in particular for anchoring a cap that closes the reservoir housing. Since vehicle brake systems for safety reasons typically have a plurality of brake circuits, and since for each brake circuit at least one pressure fluid reservoir of its own is present, in claim 9 a reservoir unit comprising a plurality of pressure fluid reservoirs is claimed, in which the reservoir housings are all closed by one common cap. This economizes on individual parts and on the effort of installation. Claim 10, as a preferred production process for a reservoir piston produced by creative shaping, recites a deep drawing process, and for the receptacle of the piston seal on the reservoir piston, it proposes a roller-burnishing process, and furthermore proposes that for cost reasons, these two method steps be performed simultaneously in one combined operation.

### DRAWINGS

One exemplary embodiment of the invention is shown in the drawing and described in further detail in the ensuing description.

FIG. 1 shows a reservoir unit comprising a total of two pressure fluid reservoirs in longitudinal section, and in

FIG. 2, an advantageous embodiment of a reservoir piston is shown in the form of an enlarged detail.

### DESCRIPTION OF THE EXEMPLARY EMBODIMENT

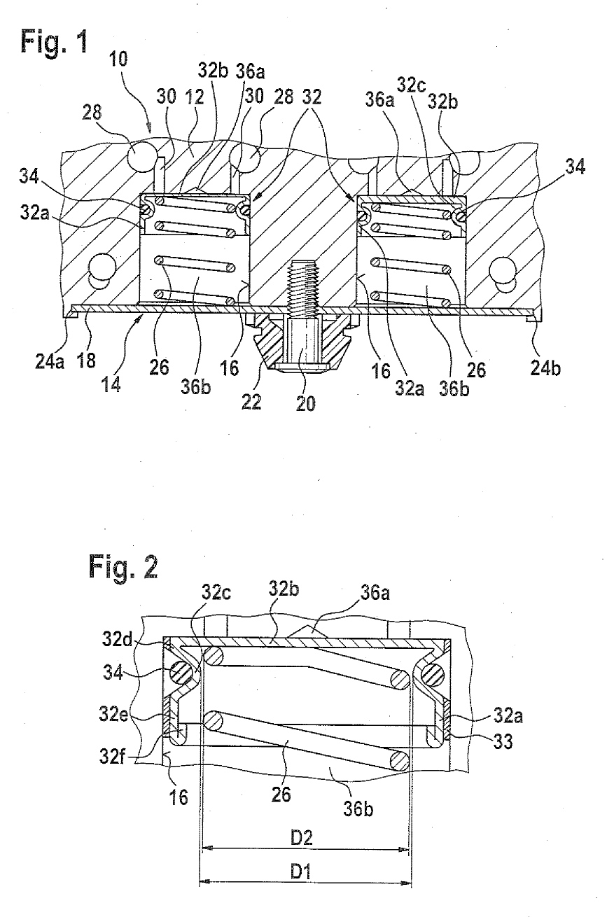

FIG. 1 shows a detail of a housing 10 of a hydraulic unit of a traction-controlled vehicle brake system. The housing 10 is formed by a metal block 12, in which installation spaces are provided for magnet valves, pumps, a pump drive, and pressure fluid reservoirs 14, among other elements. In FIG. 1, only the pressure fluid reservoirs 14 are shown, because the other components are of no significance for comprehension of the invention. Since for safety reasons vehicle brake systems typically have at least two circuits, a reservoir unit comprising a total of two pressure fluid reservoirs 14 is shown in FIG. 1. The function of the pressure fluid reservoirs 14 within a traction-controlled vehicle brake system has already been explained at the outset.

The reservoir housings 16 of the pressure fluid reservoirs 14 are formed by two separate blind bores. These bores originate at a common circumferential surface of the metal block 12 and have longitudinal axes that for example extend parallel to one another. The outward-pointing openings in the reservoir housings 16 are closed by a common cap 18. In the exemplary embodiment, this cap is anchored on the metal block 12 with the aid of fastening means 20, such as screws. The fastening means 20 moreover serves to fix a bearing element 22 on the metal block 12. The bearing element 22 is produced essentially of a vibration-damping elastomer and serves, together with further bearing elements 22 provided on the housing 10, to provide vibration-decoupled supportability of the hydraulic unit in the vehicle, for instance in a holder (not shown) provided for it. In addition to the screws or instead of them for anchoring the cap 18 of the reservoir housings 16, it would be conceivable to provide pairs of grooves 24a, 24b on the metal block 12, which extend transversely to the longitudinal axis of these reservoir housings 16 and are provided for receiving a striplike cap 18 that can be thrust into these pairs of grooves 24. The cap 18 in this case would be positionally fixed on its inside by bracing of restoring elements 26, to be described in further detail hereinafter, of the pressure fluid reservoirs 14.

It is understood that the cap 18 could also be secured in a receptacle in the metal block 12 provided for it even without fastening means, by creative shaping, for instance by calking the metal block 12 or by plastic deformation of the cap 18 itself. For each reservoir housing 16, a separate cap 18 could also be provided.

The metal block 12 is pierced by bores 28 that carry pressure fluid and that extend transversely to the longitudinal axis of the reservoir housings 16. The bores 28 communicate with the interior of the reservoir housings 16 via tie lines 30 and thus assure the supply of pressure fluid to the pressure fluid reservoirs 14. In the exemplary embodiment shown, by way of example two tie lines 30 discharge into each reservoir housing 16.

In each of these reservoir housings 16, one reservoir piston 32 is received axially movably. This reservoir piston 32 is embodied in cup-shaped form and accordingly has a cylindrical shaft 32a and a bottom 32b that closes the shaft 32a on one end. The reservoir piston 32 cooperates with the restoring element 26 in the form of a compression spring which presses the reservoir piston 32 into the basic position shown. In this basic position, the reservoir piston 32 rests with its bottom 32b in blocklike fashion on the closed end of the reservoir housing 16. To that end, the restoring element 26 is braced on one end on the inside of the bottom 32b of the reservoir piston 32 and diametrically opposite on the cap 18 that closes the reservoir housing on the outside. According to the invention, on the circumference of its shaft, the reservoir piston 32 has an integrally formed receptacle 32c. A piston seal 34 is inserted into this receptacle 32c and, in operative connection with the inner wall of the reservoir housing 16 and with the shaft 32a of the reservoir piston 32, seals off two reservoir chambers 36a, 36b from one another. The first reservoir chamber 32a, located remote from the shaft 32a, of the reservoir piston 32, can be filled as noted with hydraulic pressure fluid via the tie lines 30, while the second reservoir chamber 36b is ventilated and receives the restoring element 26. As an example, a conventional O-ring is used as the piston seal 34.

FIG. 2 shows the reservoir piston 32 again in detail. According to the invention, the reservoir piston 32 is produced by creative shaping, preferably in a deep drawing process. In proportion to its outside diameter, it has a uniformly slight wall thickness and accordingly takes up little structural space. Accordingly, the remaining installation space for the restoring element 26 inside the reservoir housing 16 is large.

It would also be conceivable in a cost-neutral way to adapt the wall thickness of the reservoir piston 32 to the loads that occur. Accordingly, the bottom 32b of the reservoir piston 32 could also have a greater wall thickness than the shaft 32a. This is shown in FIG. 1 for the right-hand piston of the two reservoir pistons 32.

The receptacle 32c on the outer circumference of the reservoir piston 32 is produced according to the invention by creative shaping. In particular, a roller-burnishing process of the kind used for instance for making incandescent bulb bases is suitable for this. For cost reasons, the production of the reservoir piston 32 and of the receptacle 32c can be performed in one combined operation. The dimensions of the receptacle 32c, piston seal 34 and restoring element 26 are preferably adapted to one another in such a way that the inside diameter D1 of the receptacle 32c is only slightly larger than the outside diameter D2 of the restoring element 26, and as a result the receptacle 32c acts as a radial brace for this restoring element 26. The receptacle 32c for the piston seal 34 is preferably disposed in the vicinity of the bottom 32b of the reservoir piston 32. The portions 32d and 32e of the shaft 32a of the reservoir piston 32 that adjoin the receptacle 32c on both sides in the axial direction preferably have the same outside diameter and form two axially spaced-apart guides, which assure the motion of the reservoir piston 32 in the blind bore 16 of the reservoir housing by counteracting tilting or clamping of the reservoir piston 32.

To improve the friction conditions between the reservoir piston 32 and the reservoir housing, these portions 32d and 32e that form guides can be provided with a friction-reducing coating 33, for instance a painted coating. Adhesive films secured to the guides and made of pressure-fluid-resistant and friction-reducing material are also conceivable for this purpose.

The open end of the reservoir piston 32, to further improve the sliding properties of the reservoir piston 32, may have a region 32f that is rolled inward, as can be seen in FIG. 2. Sharp edges on the reservoir piston 32 which could dig into the wall of the blind bore 16 of the reservoir housing are thus avoided.

It is understood that modifications or additions to the exemplary embodiment described are conceivable without departing from the fundamental concept of the invention.

1-10. (canceled)

11. In a pressure fluid reservoir for an electronically traction-controlled vehicle brake system, the reservoir having a reservoir housing in which a reservoir piston is disposed axially displaceably counter to the force of a restoring element, and the reservoir piston, in a circumferentially encompassing receptacle, has a piston seal which divides the interior of the pressure fluid reservoir into two separate reservoir chambers, and one of the two reservoir chambers can be filled with hydraulic pressure fluid,
the improvement wherein the reservoir piston comprises a one-piece component, reshaped in non-metal-cutting fashion from a sheet-metal material, and wherein the receptacle for the piston seal is integrally formed in non-metal-cutting fashion on the reservoir piston.

12. The pressure fluid reservoir as defined by claim 11, wherein the reservoir piston comprises a cylindrical shaft, which is closed on one end by a piston bottom, and wherein the shaft and the bottom have different wall thicknesses.

13. The pressure fluid reservoir as defined by claim 11, wherein the restoring element is disposed in at least some portions in the interior of the reservoir piston and is adapted in its outside diameter to the inside diameter of the receptacle for the piston seal in such a way that the receptacle forms a radial brace for the restoring element.

14. The pressure fluid reservoir as defined by claim 12, wherein the restoring element is disposed in at least some portions in the interior of the reservoir piston and is adapted in its outside diameter to the inside diameter of the receptacle for the piston seal in such a way that the receptacle forms a radial brace for the restoring element.

15. The pressure fluid reservoir as defined by claim 12, wherein the cylindrical shaft of the reservoir piston is rolled inward in some portions, in its region remote from the bottom.

16. The pressure fluid reservoir as defined by claim 12, wherein the portions of the shaft that axially adjoin the receptacle for the piston seal form guides, spaced apart from one another, for the reservoir piston in the reservoir housing, and wherein these guides are provided with a friction-reducing coating.

17. The pressure fluid reservoir as defined by claim 13, wherein the portions of the shaft that axially adjoin the receptacle for the piston seal form guides, spaced apart from one another, for the reservoir piston in the reservoir housing, and wherein these guides are provided with a friction-reducing coating.

18. The pressure fluid reservoir as defined by claim 15, wherein the portions of the shaft that axially adjoin the receptacle for the piston seal form guides, spaced apart from one another, for the reservoir piston in the reservoir housing, and wherein these guides are provided with a friction-reducing coating.

19. The pressure fluid reservoir as defined by claim 16, wherein the friction-reducing coating is formed by a painted coating and/or an adhesive film with friction-reducing properties.

20. The pressure fluid reservoir as defined by claim 17, wherein the friction-reducing coating is formed by a painted coating and/or an adhesive film with friction-reducing properties.

21. The pressure fluid reservoir as defined by claim 18, wherein the friction-reducing coating is formed by a painted coating and/or an adhesive film with friction-reducing properties.

22. The pressure fluid reservoir as defined by claim 11, wherein the reservoir housing is formed by a blind bore in a metal block, the end of the blind bore open toward the outside being closed by a cap and the restoring element being braced on the inside of the cap; and wherein the cap is anchored to the metal block by fastening means, with which simultaneously means for vibration-damped supportability of the metal block are fixed.

23. The pressure fluid reservoir as defined by claim 12, wherein the reservoir housing is formed by a blind bore in a metal block, the end of the blind bore open toward the outside being closed by a cap and the restoring element being braced on the inside of the cap; and wherein the cap is anchored to the metal block by fastening means, with which simultaneously means for vibration-damped supportability of the metal block are fixed.

24. The pressure fluid reservoir as defined by claim 13, wherein the reservoir housing is formed by a blind bore in a metal block, the end of the blind bore open toward the outside being closed by a cap and the restoring element being braced on the inside of the cap; and wherein the cap is anchored to the metal block by fastening means, with which simultaneously means for vibration-damped supportability of the metal block are fixed.

25. The pressure fluid reservoir as defined by claim 15, wherein the reservoir housing is formed by a blind bore in a metal block, the end of the blind bore open toward the outside being closed by a cap and the restoring element being braced on the inside of the cap; and wherein the cap is anchored to the metal block by fastening means, with which simultaneously means for vibration-damped supportability of the metal block are fixed.

26. The pressure fluid reservoir as defined by claim 11, wherein the reservoir housing is formed by a blind bore in a metal block, the end of the blind bore open toward the outside being closed by a cap and the restoring element being braced on the inside of the cap; and wherein pairs of grooves into which the cap can be thrust, that extend transversely to the longitudinal axis of the blind bore are embodied on the metal block.

27. The pressure fluid reservoir as defined by claim 12, wherein the reservoir housing is formed by a blind bore in a metal block, the end of the blind bore open toward the outside being closed by a cap and the restoring element being braced on the inside of the cap; and wherein pairs of grooves into which the cap can be thrust, that extend transversely to the longitudinal axis of the blind bore are embodied on the metal block.

28. The pressure fluid reservoir as defined by claim 13, wherein the reservoir housing is formed by a blind bore in a metal block, the end of the blind bore open toward the outside being closed by a cap and the restoring element being braced on the inside of the cap; and wherein pairs of grooves into which the cap can be thrust, that extend transversely to the longitudinal axis of the blind bore are embodied on the metal block.

29. A reservoir unit comprising a plurality of pressure fluid reservoirs as defined by claim 11, wherein the reservoir housings are formed by blind bores in a metal block whose openings are closed by a common cap.

30. A method for producing a pressure fluid reservoir as defined by claim 11, wherein the reservoir piston is produced by deep drawing and the receptacle for the piston bottom is produced by roller-burnishing.
